(19) United States
(12) Patent Application Publication
(10) Pub. No.: US 2007/0162259 A1
(43) Pub. Date: Jul. 12, 2007

(54) Method for converting a log of user manipulations of a computer program into task documentation

(76) Inventors: Tricia York Garrett, Raleigh, NC (US); Pamela Sherwood Helyar, Morrisville, NC (US); Jana Helton Jenkins, Raleigh, NC (US)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/328,846

(22) Filed: Jan. 10, 2006

(51) Int. Cl. G06F 17/00

(52) U.S. Cl. 702/186; 702/127; 702/182

(57) ABSTRACT

A log of user manipulations to accomplish a task within a computer program is used to create a comprehensive task document for the application. Initially, a log of user interactions is obtained for an application task. The log strings are presented in a standard format of alphanumeric pseudo code representations for interaction events, as such the log string information cannot be readily understood without the aid of a code document for the application. A mapping file is than created that defines the relationships between log strings and corresponding strings of descriptive information for user manipulations and other related information. The corresponding strings of descriptive information include a description of each user interaction and identify all screen objects and the like that might be manipulated by the user. From this mapping, a comprehensive task document for a task can then be created from the log of user manipulations for accomplishing the task by correlating the log with the mapping file and compiling matching definitions of a task file. Furthermore, the same mapping file can be used in the documentation of multiple tasks this way.

### BACKGROUND OF THE INVENTION

1. Field of the Invention

The present invention relates to creating documentation for an application task. More particularly, the present invention relates to a system, method and software program product for automatically generating task documentation from an output log of user interactions.

2. Description of Related Art

Software documentation is usually a set of technical manuals or program listings that describe the operation and uses for a particular software application. In application development, creating software code alone is inadequate for realizing the full potential of the application. Typically, some descriptive text must be created along with the code to describe the various aspects of its operation. Often, cursory documentation is embedded within the application code itself, usually by the application developer, which is accessible to programmers and others having the authority to traverse the code. At this level, the documentation is highly technical and principally used to define and explain the routines, API's, log events, data structures and algorithms within the code. This type of software documentation is often referred to as code documents, because it describes the code itself, rather than its operations, applications or uses. Code documents do not give the operator of the application any particular insight on application features, how to execute the application routines and features or their uses.

User documentation, or user documents, describe particular application features, their uses and the various steps required to successfully execute the individual features of a software application. Among other things, the user documentation describes the various steps required for the user to effectively interact with it. Good user documents provide users with reference information for commands and menu items. They are usually organized to aid in the understanding of application tasks and routines as well as help users prevent and recover from user action errors. While the organization of the user documentation can vary, it is imperative that the low-level application tasks be completely and accurately documented.

User documentation often is generated long after the software application has been created. Typically, the task of creating user documentation for an application is either assigned to the development team or an independent team of writing professionals. Interestingly, while the code documents are created by software application developers who are innately familiar with it, often the author of a user document has little or no insight into the coding and desired use of a particular application. Nevertheless, it is the job of the document author to explain the technology of a software application in a way that non-technical people, and those unfamiliar with the particular application, can use and understand it.

Developing task documentation and/or scenarios that provide a user with concrete steps for the user to follow to complete a task in a computer program is a time-consuming and labor-intensive process. The author of the task documentation has to compose a description of each step that a user performs in the software application and add the completed steps to a documentation file. Sometimes, the document author is required to obtain or discover additional information about how to perform the task. Typically, each new bit of information gathered by the author is validated with the application prior to including the new information into a descriptive step. Eventually, the completed steps are compiled into a task document, which also necessitates someone validating the documentation by performing the task steps using the application. This work is especially important because, unlike code documentation, the user documentation was not produced directly and automatically from the code itself.

### BRIEF SUMMARY OF THE INVENTION

The present invention is derected to a system, method and software product for using a log of user manipulation within a computer program to compile a comprehensive task document. Many software applications support the production of a log or record of user manipulations within a program. The event information in a log cannot be readily understood without the aid of a code document for the application, but is presented in a standard format of alphanumeric pseudo code representations of time (or an event sequence identifier), screen objects and locations, and task, application and user actions. These representations are defined, or described, and organized in a mapping file corresponding to comprehensible definitions for the log string. A comprehensive task document for a task can then be created from a log of user manipulations for accomplishig the task. The tadk document is created by traversing the log, looking up the matching definitions in the mapping file, and compiling those matching definitions in a task document.

### BRIEF DESCRIPTION OF THE SEVERAL VIEWS OF THE DRAWINGS

FIG. 1 is a flowchart depicting a method for creating user documentation for an application task as practiced in the prior art;

FIG. 2 is a flowchart depicting a method for using a log of user manipulations within a computer program to create a task document in accordance with an exemplary embodiment of the present invention;

FIG. 3 is a flowchart depicting a method for generating a mapping file for defining the relationships between log strings and corresponding descriptive information for user manipulations and other related information in accordance with an exemplary embodiment of the present invention; and

FIG. 4 is a flowchart depicting a lower level method for converting the user log to task documentation in accordance with an exemplary embodiment of the present invention.

Other features of the present invention will be apparent from the accompanying drawings and from the following detailed description.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk or C++. However, the computer program code for carrying out operations of the present invention may also be written in procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Software applications are typically documented as a set of technical manuals or program listings that describe the operation and uses of a particular software application. This documentation usually takes the form of at least two distinct documentation types: code documentation, that is interspersed in the program code by the application developer; and user documentation (sometimes referred to as task documentation), that is often generated after the application's development by the author. Code documentation is authored from the perspective of an application developer, because, ultimately, it will be of consequence only to the development team and other technical troubleshooters. Conversely, user documentation is created from the perspective of the end user since it will be utilized by users of the application. The user document is an invaluable reference resource to the user for commands and menu items and aids in the understanding of application tasks and routines as well as helps users prevent and recover from user action errors.

Code documentation is generated simultaneously with the code to describe the various aspects of its operation and is accessible to programmers and others having the authority to traverse the code. Since code documentation is written for developers and the like, it is highly technical and principally used to define and explain the routines, API's, log events, data structures and algorithms within the code. Code documentation is not very useful to an end user of the application as it does not provide any particular insight on application features, how to use the application routines or how to successfully execute a particular application task. Good user documentation, on the other hand, provides the user with a comprehensive guide to operate the application and perform specific application tasks. Characteristically, user documentation is organized and written to a level that can be understood by anyone who may interact with the application, even those users who are unfamiliar with the application but have the prerequisite skills for the defined audience. Often, a task document is composed of a sequence of relatively short steps, describing how to perform a particular task and using non-technical language such that the document is easily understandable to the end user.

Writing task documentation for software applications that have multiple panels is a time-consuming and labor-intensive process. A software application might have fifty or more panels and hundreds of possible combinations of interface selections. Until steps on how to complete tasks within the application are documented, usually only the application developer knows how to use the application. Before other people can test, prepare task documentation for and perform tasks with the application, the application developer commonly must describe the application to those people and provide specific steps on how to use the application. The invention offers a quick way for the application developer, or any user, to generate task documentation.

The beneficiaries of the generated task documentation can be anyone seeking to communicate to others less familiar with the application how to complete a specific task. A central beneficiary is also the author of user documentation for the application.

If the author is not also the application developer, to prepare user documentation for an application, the author must often discover or obtain more explanation about a particular application, its user features, friendliness, advantages, disadvantages, shortcuts, tips, traps and modifications from the predecessor version, as well as the most optimal way to interact with the subject application. The author may attempt to gain a better understanding of the application from a developer or other person who is more proficient with the application. However, every communication between the document author and the software specialist can be time consuming and is susceptible to error, omission and interpretation. Sometimes a transcript of descriptive information that is important for documenting the application is incomplete or corrupt. Therefore, each descriptive step in the final user document must be meticulously validated with the application, whether discovered through direct use of the application or obtained by interviewing an expert with the application. Furthermore, although various tasks might share steps and sequences of steps in common, typically these step descriptions are not reused “as is” in various points in the user documentation—or if they are, it is through authoring processes that still require much human intervention and judgment. Each task document must be validated separately, consuming valuable time from software professionals. The prior art process for preparing user documentation for an application task will be better understood with regard to a description of the flowchart below.

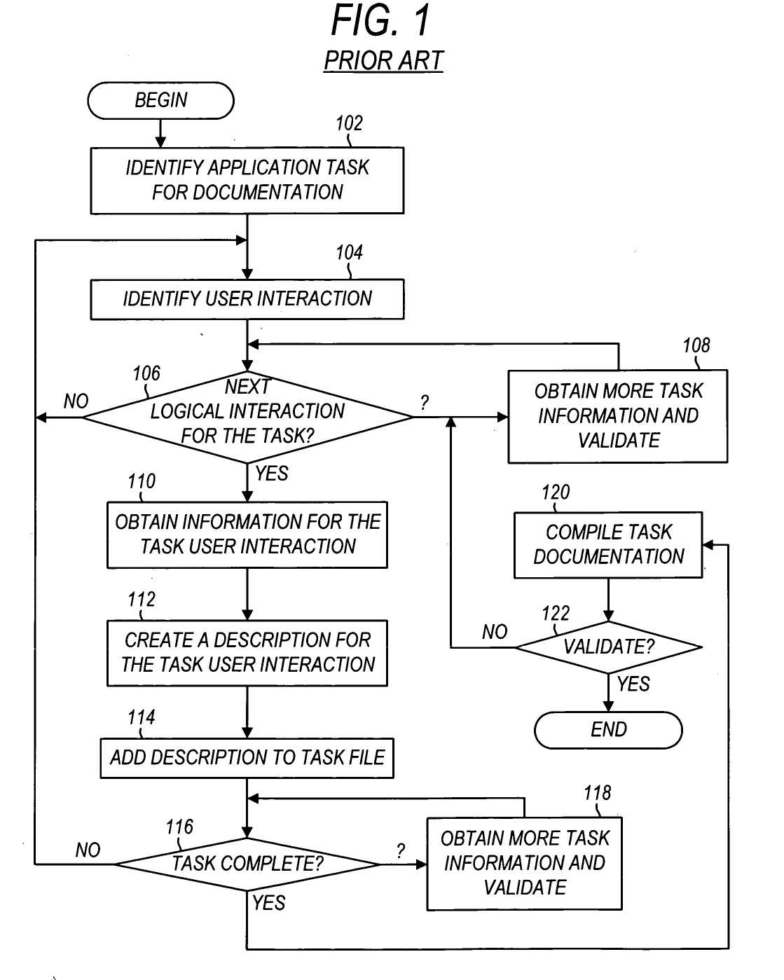

FIG. 1 is a flowchart depicting a method for creating user documentation for an application task as practiced in the prior art. Optimally, the document author will have access to the application and have a complete understanding of its function, but this is rarely the case. It is expected that the document will be organized in a series of related tasks and each task described as a sequence of user interactions, or steps, necessary to achieve a successful conclusion to the task. The process begins by identifying an application task to describe (step 102). The user then identifies a user interaction associated with the task (step 104). Because each task will be described in the document as a sequence of user interactions necessary to achieve a successful outcome, a determination is made as to whether or not the identified interaction is the next logical user interaction in the task sequence (step 106). The document author might need to research or discover more information about the application task to decide (step 108). The author validates any information that may confirm or refute that the current interaction is not the next user interaction in the logical flow of the task. If the current user interaction is out of logical sequence, the process iterates between steps 104 and 106 until the correct interaction has been identified for the current stage of task completion.

Once the proper task is identified, it may again be necessary for the document author to obtain or discover additional information concerning the user interaction and the application's response (step 110). Here again, before relying on any external information, the author will validate the task information with the application. As the author will ultimately compile a complete record of user interactions and application responses for the task, the description of each task step should identify any fields, windows, interactive graphical objects, hot spots, and/or screen positions displayed for the user to invoke a command and/or user interaction, make an entry and the content of the entry, along with a description of any visual confirmation to the user interaction and finally a description of the response from the application task. The description is prepared (step 112) and included in a task file (step 114).

A check is made after each step to determine whether or not the task file is complete (step 116). As before, the author may need more information to make the decision, and then validate the new information (step 118). If the task is not complete, the preparation process iterates between steps 104 and 116 until the author verifies that the task is complete. Once complete, the cumulative description in the task file is compiled into a task document (step 120). Although the author is likely to have validated one or more individual steps, at this point, the author validates the end-to-end task document by performing the application task (step 122). The author will use this opportunity to supplement the task document with any additional description, observed while running the application task that might be helpful to a user. If the task document accurately reflects the user's interactions within the application, the application responses and visual layouts, and then reaches a proper conclusion for the task, the process ends. However, if the task document cannot be validated by running the actual task, the preparation process reverts to step 108 and the process continues to iterate from step 104 until the task documentation can be verified.

It should be clear from the discussion above that documenting an application task can sometimes entail many iterations of research and discovery, writing, verifying, more research and discovery, writing, etc. The problem is exacerbated by the need to involve others when these traits cannot be discovered firsthand. Their availability and cost increase the time and expense for preparing a task document.

In accordance with one exemplary embodiment of the present invention, a task document is created from a log recorded of user manipulations for accomplishing a particular application task. Many software applications support the production of a log or record of user manipulations within a program. Additionally, many independent tools exist for capturing and logging user interactions with other software. A log or record of user manipulations notes each action event associated with a particular software application, usually in the sequence the events occurred. Such software applications can produce a log file or other record of the push buttons, menu choices, list items, and navigation hyperlinks that a user selects and what text a user enters into text fields. A log record commonly is presented in a standard format, with alphanumeric pseudo code representations for time (or an event sequence identifier), screen objects and locations, and for task, application and user actions. An exemplary format for a typical log string of an event may take the form of: <YYYYMMdd hhmmss><objectID><action(app/user)><‘entry/display string’>. Typically, the event information in this type of log cannot be readily understood without the aid of a code document for the application. Below is a record of user manipulations depicted as information strings in an exemplary log file.

| | | |
|---|---|---|
| 20041106 | 083858 | TL draw complete |
| 20041106 | 083909 | TL.b3 clicked |
| 20041106 | 083910 | TL.prompt1 draw complete |
| 20041106 | 083912 | TL prompt1.field1 enabled |
| 20041106 | 083933 | TL.prompt1.b1 clicked |
| 20041106 | 083933 | TL.custList.item09 set ‘Investment, Inc.’ |
| 20041106 | 083934 | TL.prompt1 close complete |
| 20041106 | 083934 | TL draw complete |
| 20041106 | 083939 | TL.custList.item09 enabled |
| 20041106 | 083939 | TL draw complete |
| 20041106 | 083942 | TL.servList.item3 enabled |
| 20041106 | 083942 | TL.servList.item3 is ‘Assessment’ |
| 20041106 | 083942 | TL.b6 enabled |
| 20041106 | 083942 | TL draw complete |
| 20041106 | 083944 | TL.b7 clicked |
| 20041106 | 083944 | TL start timer complete |
| 20041106 | 083944 | TL.b8 enabled |
| 20041106 | 085602 | TL.b8 clicked |
| 20041106 | 085602 | TL stop timer complete |
| 20041106 | 085602 | TL customer 09 time is ‘00:16:18’ |
| 20041106 | 085602 | TL.field1 draw complete |
| 20041106 | 085602 | TL draw complete |
| 20041106 | 090112 | TL.b9 clicked |
| 20041106 | 090112 | TL.prompt3 draw complete |
| 20041106 | 090118 | TL prompt3.field1 enabled |
| 20041106 | 090124 | TL.prompt3 draw complete |
| 20041106 | 090126 | TL.prompt3.b1 clicked |
| 20041106 | 090126 | TL customer 09 write to ‘c:\cust\inv’ |
| 20041106 | 090126 | TL.prompt3 close complete |
| 20041106 | 090126 | TL draw complete |

Even if the log captures a correct sequence of user interactions to accomplish a give task, the log itself is not suitable documentation for explaining to other users how to interact with the program to perform the task. However, by using the information in the log, a log mapping file can then be created that correlates strings of information from the user manipulation log to strings of comprehensible text that describe a particular user manipulation. Many logged action events relate screen objects that are uniquely identified in the log string. Because the set of possible actions, interactions and manipulations to a particular screen object is finite, a mapping matrix can be formulated for each screen object based on all possible events. For instance, in the previous example, a particular screen object, TL.b7, will have only certain actions defined for the object based on its type. If screen object TL.b7 is an entry field, then the object will map to a description of the “set” action for the object and further explain that a user-defined entry value for the object is set apart in quotation marks. However, it may also be possible to manipulate an entry field type of screen objects in other ways. For instance, screen object TL.b7 may also map to a description of the “clicked” action for acknowledging a user entry in the field or may also map to a description of the “ENTER” keystroke action for acknowledging the entry. If, on the other hand, screen object TL.b7 is a radio button, the sole mapping would probably be to a description of the “clicked” action for selecting the radio button screen object.

The aim is to create a comprehensive task document by compiling the comprehensible descriptive text strings, mapped from a log file, directly into a task documentation file. Each unique user manipulation is represented as string of action event information in the log, but not every string of action event information represents user manipulation. Some log strings represent application and task responses to user interactions, the state of the screen objects and/or the state of application or task. Therefore, in preparing a mapping file, not only are log strings representing user manipulation mapped to comprehensible text strings describing the action, but any log string with information that may be helpful for task documentation should also be mapped to descriptive text.

The mapping between log strings and task information strings can be one-to-one, one-to-many, or many-to-one. That is, for example, a log string might correspond to one meaningful step in the resulting task documentation, or one log string might correspond to several meaningful steps. Because well-written task documentation often groups several trivial steps into one meaningful step from the user perspective, a few log strings might equate to one step in the task documentation. This invention includes (but is not limited to) embodiments that can match sequences of known log strings to one meaningful user step in the task documentation. In the following example, based on the mapping file (not shown), the heading “Create a new invoice” is inserted for improved user comprehension, when a particular sequence of log entries is encountered:

| Log entries | User task documentation |
|---|---|
| . . . | . . . |
| 20041106 083858 TL.new clicked | Create a new invoice. |
| 20041106 083933 TL.invoice.09 set ‘blah’ | 1. Click New. |
| 20041106 083933 TL.invoice.08 set ‘bank’ | 2. Set Invoice Name |
| 20041106 083933 TL.prompt1.ok clicked | to ‘blah.’ |
| 20041106 083933 TL.prompt1.save clicked | 3. Set Invoice Owner |
| 20041106 083934 TL.prompt1 close complete | to ‘bank.’ |
| . . . | 4. Click OK. |
| | 5. Click Save. |
| | 6. Click Close. |
| | . . . |

Grouping the steps this way enables the generated user task documentation output from an embodiment of this invention to rival the quality of user task documentation organized and written in the traditional way. The invention is not limited to generating a rote 600-step task document from a one-time traversal of a log containing 600 entries. Creating the mapping definitions, as well as performing the actual log-to-description mappings, is a skilled human task, involving both application and user insight, and will determine the quality of the generated output. However, once it is created, the mapping can be reused when creating the task documents for the entire realm of tasks that can be performed using the software screens in question.

Optimally, much of the content in a log file string is written in standard form, and reused throughout the application program where appropriate. Consequently, the comprehensible strings of descriptive information mapped to the log information strings may be reused in thein the task file, at each ocurrence of the corresponding string in the log record. Furthermore, because much of the log information may be transparent to the particular application that produces it, i.e., commands, application and user actions and the identities of non-contextual screen objects, the mapping file may be easily modified for use with other applications. Below is a record of a mapping file for correlating user manipulation strings from log file to comprehensible text that describe the particular user manipulation.

*********** Time Logger mapping file ***********
.**
.* General
.**
b1=“OK”
b2=“Cancel”
.**
.* Time logger window
.**
tl.title=“Time Logger”
tl.l1=“Customers”
tl.b3=“Add customer”
tl.b4=“Remove customer”
tl.l2=“Services”
tl.b5=“Add service”
tl.b6=“Remove service”
tl.l3=“Time elapsed”
tl.b7=“Start”
tl.b8=“Stop”
tl.b9=“File information”
.**
.* Customer dialog
.**
tl.prompter1.title=“Customer Identification”
tl.prompter1.l1=“Customer name or ID”
.**
.* Service dialog
.**
tl.prompter2.title=“Services”
tl.prompter2.l1=“Service provided”
.**
.* File dialog
.**
tl.prompter3.title=“File”
tl.prompter3.l1=“File name”
.************************************************

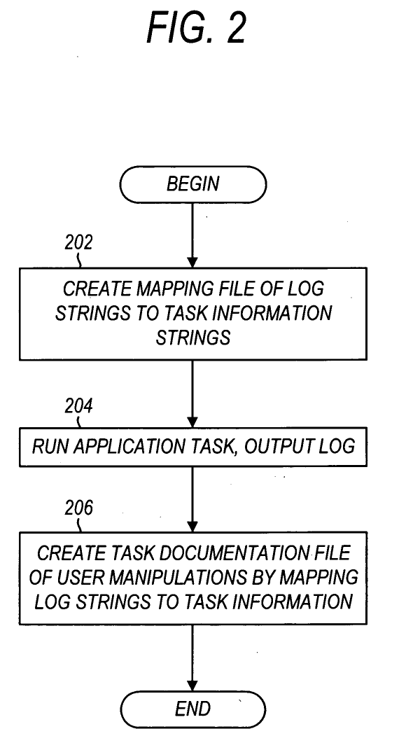

Using the mapping file, it is possible to create a comprehensive task document with only minimal human interaction. FIG. 2 is a flowchart depicting a method for using a log of user manipulations within a computer program to create a task document in accordance with an exemplary embodiment of the present invention. The process begins by creating a mapping file of user manipulation strings from a log to strings of comprehensible text that describe the particular user manipulation as discussed directly above (step 202). With the mapping file complete, a log record of an application task within a software application can be automatically converted to task documentation by merely correlating log strings to their descriptive counterparts. The log may be recorded before, after, or simultaneous with the creation of the mapping file, but the mapping definitions must be accurate. The log is recorded while a user proficient with the application performs the subject task. User interactions are simultaneously recorded to a log file (step 204). With the log file, a task document is created by sequentially correlating strings in the log to the corresponding strings of descriptive text, which are then written to a task file (step 206). The process ends with the compilation of the task document. Below is an exemplary task document created for the log example of the task, which is created using the mapping file (both discussed above).

| | |
|---|---|
| 1. | Go to the Time Logger window. |
| 2. | Click Add Customer. |
| 3. | In the Customer Identification window: |

| | |
|---|---|
| a. | For Customer name or ID, specify “Investment, Inc.”. |
| b. | Click OK. |

| | |
|---|---|
| 4. | For Services, select “Assessment”. |
| 5. | Click Start. |
| 6. | Click Stop. |
| 7. | Click File. |
| 8. | In the File window: |

| | |
|---|---|
| a. | For File name, specify “c:\cust\inv”. |
| b. | Click OK. |

The method disclosed in the flowchart of FIG. 2 may be recognized as three separate low level processes: creating a log mapping file, generating the log strings; and creating the task document from the log strings using the mapping file. The process for generating a log is well known and requires no further elaboration for practicing the present invention. However, creating the file of mapping definitions and generating the task documentation by mapping the log strings to the task definition strings from the log mapping file are separately discussed below.

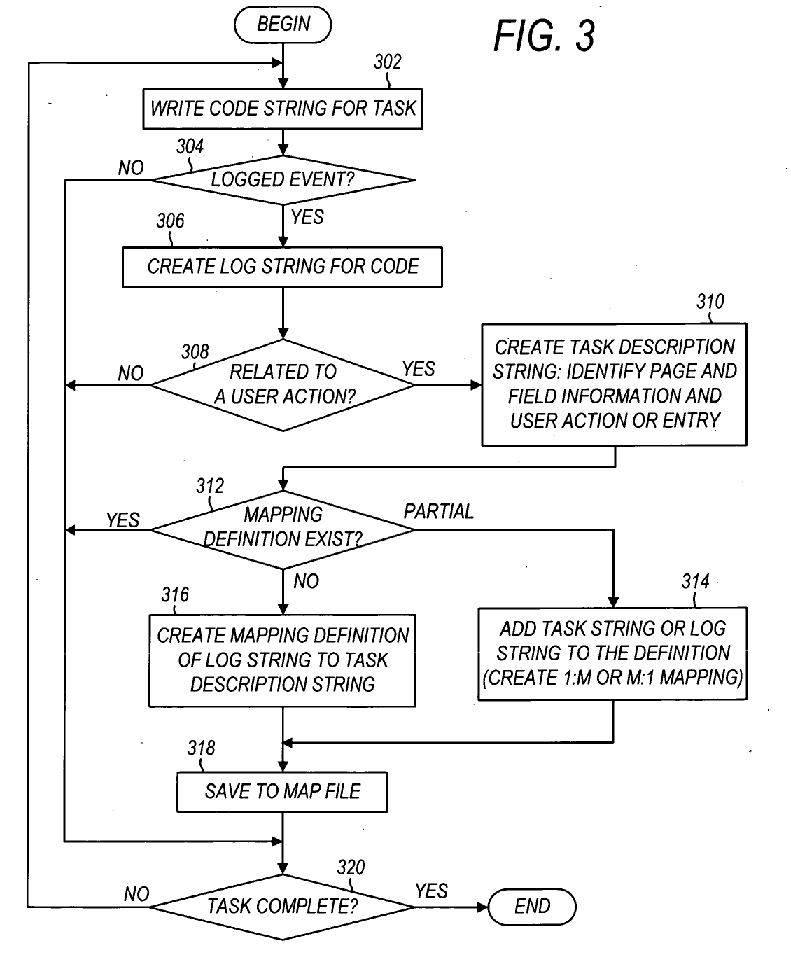

FIG. 3 is a flowchart depicting a lower-level method for creating log mapping definitions, for inclusion in a log mapping file, simultaneously with developing the application code and the corresponding log strings in accordance with an exemplary embodiment of the present invention. It should be mentioned that although the log strings for the application code and mapping definitions for the mapping file are depicted as being generated nearly simultaneously, the log mapping definitions may be created for any application capable of generating a log, even where the application code was developed beforehand. As a practical matter, the strings in the log will automatically follow the sequence of user interactions for accomplishing a task, however, the definitions in the mapping file are indexed by log string and task description string, and accessible from either index. The process begins with the developer writing a line of code for a particular application task (step 302) and checking for a logged event associated with the line of code (step 304). Importantly, not every line of code will generate a log string, and not every log string will map to a task description, therefore the process vets lines of code for any logged event without a definition. The process jumps to step 320, where a check is made for completion of the task. If the task is complete, the process ends, if not, the process flow reverts to step 302 and for another line of code.

If, at step 304, the line of code corresponds to a logged event, a log string is created for the code (step 306). Recall that a log string is usually in a standard format of an alphanumeric pseudo code representation that cannot be readily understood without the aid of a code document for the application. Only the log strings related to a user interaction are of interest, others need not be considered. Therefore, the next step is to determine whether or not the log string warrants a mapping definition, that is, if the string is related to a user action (step 308). If not, the process again jumps to step 320, and reverts back to step 302 if the task is not complete. If the log string is related to a user action, a task string is created which describes the user interaction that resulted in the log string (step 310). More particularly, the task string is a description of the alphanumeric representation of log string, which is readily understandable and, optimally, is suitable for placement directly into a user document without further human intervention (aside from stylistic changes to the description). The task string may describe a user action or user entry, or the application's visual response to a user action/entry. Additionally, the task string may also present a description of any graphic element identified in the log string.

By knowing both the log string and a task string, the log mapping file is accessed and checked for a corresponding definition already existing in the log mapping file (step 312). Recall that both the log and task strings may be reusable and therefore one, the other, or both may already exist in the mapping file and be reused. If a direct mapping definition exists in the mapping file, i.e., the current log string is already defined in the mapping file as the current task string, then another definition need not be included in the mapping file. The existing log mapping definition may be in the form of a direct 1:1 mapping where only the current log string maps to only the current task string, or one of a M:1 or 1 :M definition. In a M:1 mapping, the current log string is one of many existing log strings that maps to the current task string. Conversely, in a 1:M mapping, the current log string maps to the current task string, which is one of many existing task strings for the current log string. Optimally, the mapping definition for the current log string will exist in the mapping file, for a particular application, as either a 1:1 mapping definition or M:1 mapping definition, thereby eliminating any possible human intervention necessary for selecting the most appropriate task string definition for the particular task in which it occurs. Of course, in many case all M description will be applicable for any task in which they occur.

Conversely, if neither the log string nor the task string exist in the mapping file, one is created in the form of a 1:1 mapping definition from the current log and task strings (step 316) and included in the mapping file (step 318).

If only a partial definition exists in the mapping file (i.e., one of the log string or task string is present as part of an existing definition in the mapping file), the existing definition is modified to include the missing string (step 314), For example, if the current log string exists in the mapping file as part of a 1:1 mapping definition, but without the task string, then that definition is changed to a 1:2 mapping definition by including the current task string (with the newly created description) from with the existing task string definition already in the mapping file. A M:1 mapping definition is similarly formed by including the log string in an existing partial definition for the current task string. M:N mapping definitions are also possible, where many log strings map to many task strings, however, it should be understood that any ambiguous definitions for a log string will require human intervention for selecting the most appropriate task string definition for inclusion in the task document (step 318). The process then verifies that the task is complete (step 320) and then ends. If the task is not complete, other mapping definitions may be added to the mapping file depending on other logged events, so the process and reverts back to step 302 and iterated through steps 302-320 until the task is complete.

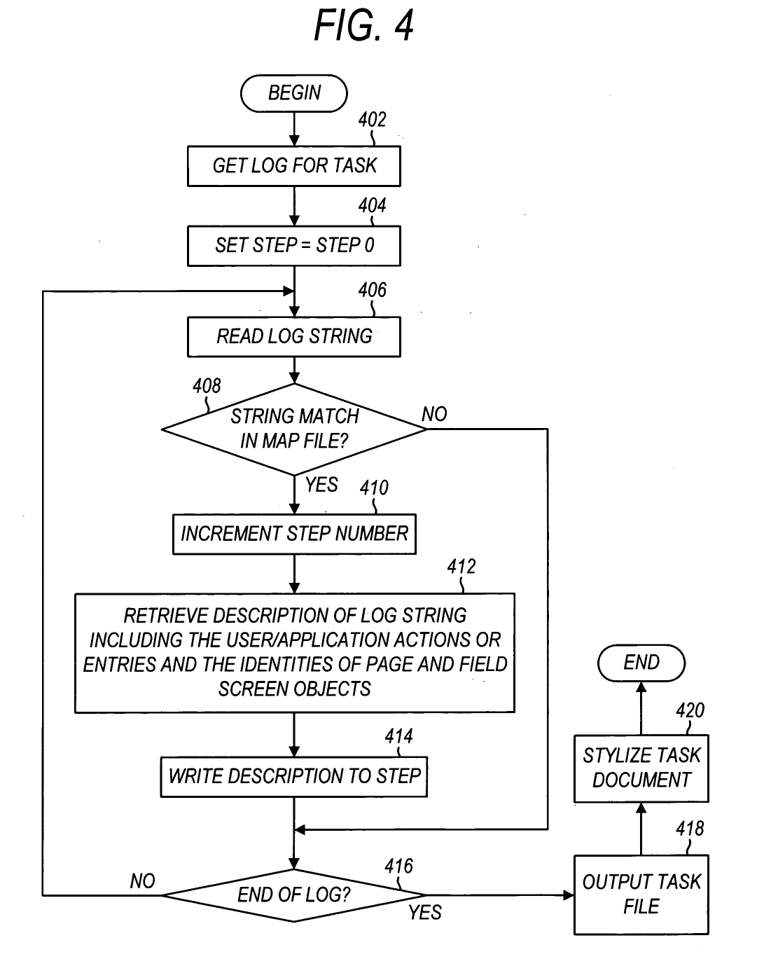

FIG. 4 is a flowchart depicting a lower-level method for converting the user log to task documentation in accordance with an exemplary embodiment of the present invention. The log of user interactions for a particular task, which was created beforehand, is accessed (step 402). The task document may be structured as a tutorial guide for performing the task by following a sequential set of steps for accomplishing the task, so the step sequence is initiated (step 404). As a log string is read (step 406), the mapping file is accessed for a comparison to the log string (step 408). If the string matches a mapping definition, the step number is incremented (step 410) and the description of the log string, including the user/application actions or entries and the identities of page and field screen objects are retrieved (step 412) and written to the step (step 414). In the case of an ambiguous definition for the log string (i.e., a 1:M mapping definition or N:M mapping definition), the most appropriate task string for the log string is selected from the existing M task strings based on the corresponding descriptions of the current log string. Only the most appropriate task description for the log string is selected and included in the task document; the remaining definitions are discarded.

Because the log can be relied on as a complete record of the user interactions to accomplish the task, the bounds of the tasks are recorded within the log and the task document can be assembled solely from the contents of the log. Thus, the end of the log signals the end for a task, which is tested (step 416). When the current log string is the final log string, the task file is complete and it may be outputted as a task document (step 418). If not, the log is traversed by iterating through steps 406 to 416, one string after another, until a comprehensive task document is compiled from the descriptive steps for the user manipulations.

It should be appreciated that not all human intervention in the documentations process can be dispensed with out of hand. While the task document compiled from the descriptive steps is essentially complete, very accurate, and represents a comprehensive guide for operating the application and performing specific application tasks, some stylistic changes may be desirable for readability (step 420). As mentioned above, various tasks might share steps and sequences of steps in common, and therefore the log definitions for those steps may be reused. However, the steps generated from these definition descriptions may not completely or accurately describe the step in the context of disparate tasks. Thus, in some cases the descriptive definitions should not be reused “as is” in various points in the user documentation, but instead they should be fine-tuned for the particular task they occur, which still requires some human intervention and judgment on the part of the document author. It may be desirable to include some contextual or transitional language in the task steps that acknowledges the particular task as being unique from other application tasks, and also recognizes the preceding/succeeding interaction steps. Log definitions are predicated solely on a particular log string, not the uniqueness of the task the definition may occur in or where, in the sequence of task steps, the description may occur. Thus, it may be beneficial for the user to include some contextual language for a particular task in which the task description occurs and/or some transitional language that recognizes the contribution of the particular task step with regard to the predecessor or successor steps. Also, a reoccurring log string will result in the identical task description being repeated throughout the task document and may affect readability. At a minimum, the author should consider truncated each duplicative instance of the task definition after the first occurrence of the sting within a particular task, or some other repetitive amount, say every other occurrence. Additionally, bullets, numbering and outline formatting can also be included that is consistent with the remainder of the task document. The task document can then be output as comprehensible text that describes the particular sequence of user manipulations necessary for accomplishing the task.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systens which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the tems “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method for generating a task document from an output log of user interactions within a software application, comprising:
accessing an output log for representing user interactions within a software application, the output log comprising a plurality of log strings defining a sequential record of interaction events and which further identify user action objects associated with the interaction events;
correlating each of the plurality of log strings in the output log to a task description for the respective log string, wherein said task description is one of a user interaction description and action object identifier; and
compiling a task document from the correlated task descriptions of user interactions and action object identifiers for the respective log strings.

2. The method recited in claim 1, further comprises:
creating a plurality of log mapping definitions, wherein a mapping definition for each log string correlates to a task description for the respective log string, said log string correlate to one of a unique description of a user interaction and a unique description of a action object.

3. The method recited in claim 2, wherein each of the plurality of log mapping definitions are one of a one to one mapping definition, a one to many mapping definition and a many to one mapping definition.

4. The method recited in claim 2, wherein correlating each of the plurality of log strings in the output log to a task description for the respective log string, further comprises:
iterating through each log string in the output log; and
matching at least some interaction events and user action objects in the log string of the output log to a unique description of a user interaction.

5. The method recited in claim 4, further comprises:
sequentially identifying each successfully matched iteration of the sequential record of interaction events and user actions.

6. The method recited in claim 4, further comprises:
producing a task document from the compilation of mapping definitions of unique descriptions of user interactions for the respective log strings.

7. The method recited in claim 1, further comprises:
executing a task in the software application; and
producing the output log of user interactions within the software application.

8. The method recited in claim 7, wherein native code of the software application supports production of the output log of user interactions.

9. The method recited in claim 2, wherein creating a plurality of log mapping definitions, wherein a mapping definition for each log string correlates to a task description for the respective log string, said log string correlate to one of a unique description of a user interaction and a unique description of a action object further comprises reusing an existing log definition.

10. A computer program product comprising a computer usable medium having computer usable program code to generate a task document from an output log of user interactions within a software application for backing up temporal data, said computer program product comprising:
computer usable program code to access an output log for representing user interactions within a software application, the output log comprising a plurality of log strings defining a sequential record of interaction events and which further identify user action objects associated with the interaction events;
computer usable program code to correlate each of the plurality of log strings in the output log to a task description for the respective log string, said task description being one of a user interaction description and action object identifier; and
computer usable program code to compile a task document from the correlated task descriptions of user interactions and action object identifiers for the respective log strings.

11. The computer program product recited in claim 10, further comprises:
computer usable program code to create a plurality of log mapping definitions, wherein a mapping definition for each log string correlates to a task description for the respective log string, said log string correlate to one of a unique description of a user interaction and a unique description of a action object.

12. The computer program product recited in claim 11, wherein each of the plurality of log mapping definitions are one of a one to one mapping definition, a one to many mapping definition and a many to one mapping definition.

13. The computer program product recited in claim 11, wherein the computer usable program code to correlate each of the plurality of log strings in the output log to a task description for the respective log string, further comprises:
computer usable program code to iterate through each log string in the output log; and
computer usable program code to match at least some interaction events and user action objects in the log string of the output log to a unique description of a user interaction.

14. The computer program product recited in claim 13, further comprises:
computer usable program code to sequentially identify each successfully matched iteration of the sequential record of interaction events and user actions.

15. The computer program product recited in claim 13, further comprises:
computer usable program code to produce a task document from the compilation of mapping definitions of unique descriptions of user interactions for the respective log strings.

16. The computer program product recited in claim 10, further comprises:
computer usable program code to execute a task in the software application; and
computer usable program code to produce the output log of user interactions within the software application.

17. The computer program product recited in claim 16, wherein native code of the software application supports production of the output log of user interactions.

18. The computer program product recited in claim 11, wherein computer usable program code to create a plurality of log mapping definitions, wherein a mapping definition for each log string correlates to a task description for the respective log string, said log string correlate to one of a unique description of a user interaction and a unique description of a action object further comprises reusing an existing log definition.

19. A system for generating a task document from an output log of user interactions within a software application for backing up temporal data comprising:
a memory for storing an output log for representing user interactions within a software application, the output log comprising a plurality of log strings defining a sequential record of interaction events and which further identify user action objects associated with the interaction events;
an input device to receive correlation information for each of the plurality of log strings in the output log to a task description for the respective log string, wherein said task description is one of a user interaction description and action object identifier; and
a data processor to compile a task document from the correlated task descriptions of user interactions and action object identifiers for the respective log strings.

20. The system recited in claim 19, wherein the data processor creates a plurality of log mapping definitions, wherein a mapping definition for each log string correlates to a task description for the respective log string, said log string correlate to one of a unique description of a user interaction and a unique description of a action object.
